(19) United States
(12) Patent Application Publication
(10) Pub. No.: US 2025/0077393 A1
(43) Pub. Date: Mar. 6, 2025

(54) METHOD FOR TESTING A COMPUTER PROGRAM

(71) Applicant: Robert Bosch GmbH, Stuttgart (DE)

(72) Inventors: Maria Irina Nicolae, Stuttgart (DE); Max Camillo Eisele, Ludwigsburg (DE)

(21) Appl. No.: 18/788,525

(22) Filed: Jul. 30, 2024

(30) Foreign Application Priority Data
Sep. 6, 2023 (DE) 10 2023 208 601.8

(51) Int. Cl. G06F 11/36

(52) U.S. Cl. CPC G06F 11/3676; G06F 11/3684; G06F 11/3688

(57) ABSTRACT

A method for testing a computer program. The method includes training a machine learning model to predict, for each test input supplied thereto, a coverage of the computer program that is achieved when the computer program is executed with the test inputs as inputs, testing the computer program in a plurality of iterations, wherein in each iteration a test input is generated, the trained machine learning model is used to predict a coverage of the computer program that is achieved when the computer program is executed with the generated test input as input, it is ascertained whether the predicted coverage increases an overall coverage previously achieved by testing the computer program, and, in response to ascertaining that the predicted coverage increases the overall coverage previously achieved by testing the computer program, the computer program is executed with the generated test input.

### CROSS REFERENCE

The present application claims the benefit under 35 U.S.C. § 119 of German Patent Application No. DE 10 2023 208 601.8 filed on Sep. 6, 2023, which is expressly incorporated herein by reference in its entirety.

### FIELD

The present disclosure relates to a method for testing computer programs.

### BACKGROUND INFORMATION

Testing is an essential part of the development of software applications. In particular, bugs that result in the failure of an application should be identified and corrected. One example of software testing is the dynamic software testing method of fuzzing.

A black-box fuzzer generates inputs for a target program (i.e., a computer program to be tested) without knowing its internal behavior or its implementation; i.e., the computer program is a black-box computer program from the fuzzer's point of view. So, in this case, the source code of the target program is not available (to the fuzzer), which prevents the fuzzer from getting feedback regarding the coverage achieved during testing (e.g., any kind of code coverage, such as path, line or branch coverage), which guides the generation of additional test cases. A black-box fuzzer thus tests practically at random and has no opportunity of improving over time. This is customary when testing embedded devices and their software.

A gray-box fuzzer would be much more effective, i.e. a fuzzer that does not have the program code but does have coverage information and can select test inputs accordingly. However, obtaining this coverage information, for example by using an emulator or instrumentation, is time-consuming and difficult, especially for embedded systems.

Therefore, low-effort approaches that enable gray-box fuzzing of black-box computer programs, in particular computer programs for embedded systems, are desirable.

### SUMMARY

According to various embodiments of the present invention, a method for testing a computer program is provided, comprising training a machine learning model to predict, for each test inputs supplied thereto, a coverage of the computer program that is achieved when the computer program is executed with the test inputs as inputs, testing the computer program in a plurality of iterations, wherein in each iteration
a test input is generated (e.g., by mutating a previous test input or a seed from a corpus);
the trained machine learning model is used to predict a coverage of the computer program that is achieved when the computer program is executed with the generated test input as input (i.e., the generated test input is supplied to the trained machine learning model and the output of the trained machine learning model in response to this input is taken as an estimate of the coverage);
it is ascertained whether the predicted coverage increases an overall coverage previously achieved by testing the computer program; and
in response to ascertaining that the predicted coverage increases the overall coverage previously achieved by testing the computer program, the computer program is executed with the generated test input.

The method described above enables gray-box fuzzing for black-box computer programs, in particular in the case of fuzzing for software for embedded systems (or devices), since the options of using other approaches to achieve gray-box fuzzing (such as static instrumentation or the use of an emulator) are severely limited.

The coverage is, for example, a code coverage such as a path, line or branch coverage or also information as to which functions or other program parts (such as functions) are achieved when the computer program is executed with the particular test input as input.

According to various embodiments of the present invention, the machine learning model (e.g., neural network) is trained individually for the computer program to be tested. Nevertheless, this can be done on the basis of a machine learning model that has been pre-trained for one or more other computer programs.

If it is ascertained that the predicted coverage does not increase the overall coverage previously achieved by testing the computer program, the generated test input is, for example, discarded (i.e., no test run is performed for it).

Various exemplary embodiments are specified below.

Exemplary embodiment 1 is a method for testing a computer program as described above.

Exemplary embodiment 2 is a method according to exemplary embodiment 1, wherein in each iteration the test input is generated from a different test input depending on whether the coverage predicted by the trained machine learning model for the different test input increases the overall coverage achieved by the testing prior to executing the computer program with the different test input as input.

The estimate of the oracle can thus not only be used in order to decide whether a particular test case is executed for a test input, but also whether the test input is used as the basis for generating further test inputs (i.e., added to the corpus, for example). In other words, the method can therefore also comprise, in response to ascertaining that the predicted coverage increases the overall coverage previously achieved by testing the computer program, adding the generated test input to a set of test inputs from which test inputs for further iterations are generated (e.g., by mutation). Thus, the efficiency of the fuzzing can be increased.

Exemplary embodiment 3 is a method according to exemplary embodiment 1 or 2, further comprising checking whether executing the computer program with the generated test input has increased the overall coverage achieved during testing of the computer program, and, in response to the execution of the computer program with the generated test input having increased the overall coverage achieved during testing of the computer program, adding the generated test input to a set of test inputs from which test inputs for further iterations are generated.

Thus, the prediction of the machine learning model (oracle) can be verified, so that only test inputs that have actually led to an increase in overall coverage are added to the corpus. The verified coverages can also be used as ground truth information for further training of the machine learning model. Thus, the efficiency of the fuzzing can be increased.

Exemplary embodiment 4 is a method according to one of exemplary embodiments 1 to 3, comprising generating the test input on a test system, ascertaining the coverage of the computer program on the test system, and in response to the test system ascertaining that the predicted coverage increases the overall coverage previously achieved by testing the computer program, executing the computer program with the generated test input on a system embedded with the test system.

The method thus enables gray-box fuzzing of a black-box computer program for an embedded system.

Exemplary embodiment 5 is a software test system which is configured to perform a method according to one of exemplary embodiments 1 to 4.

Exemplary embodiment 6 is a computer program comprising instructions which, when the instructions are executed by a processor, cause the processor to perform a method according to one of exemplary embodiments 1 to 4.

Exemplary embodiment 7 is a computer-readable medium storing instructions which, when the instructions are executed by a processor, cause the processor to perform a method according to one of exemplary embodiments 1 to 4.

In the drawings, similar reference signs generally refer to the same parts throughout the various views. The drawings are not necessarily true to scale, with emphasis instead generally being placed on the representation of the principles of the present invention. In the following description, various aspects of the present invention are described with reference to the figures.

### BRIEF DESCRIPTION OF THE DRAWINGS

FIG. 1 shows a computer for the development and/or testing of software applications, according to an example embodiment of the present invention.

FIG. 2 illustrates the data capture for training a machine learning model to predict coverage, according to an example embodiment of the present invention.

FIG. 3 illustrates the training of a machine learning model by means of the training data captured according to FIG. 2, according to an example embodiment of the present invention.

FIG. 4 illustrates fuzzing controlled by means of the machine learning model trained according to FIG. 3, according to an example embodiment of the present invention.

FIG. 5 shows a flowchart that represents a method for testing a computer program according to one example embodiment of the present invention.

### DETAILED DESCRIPTION OF EXAMPLE EMBODIMENTS

The following detailed description relates to the accompanying drawings, which show, by way of explanation, specific details and aspects of this disclosure in which the present invention can be executed. Other aspects may be used and structural, logical, and electrical changes may be performed without departing from the scope of protection of the invention. The various aspects of this disclosure are not necessarily mutually exclusive, since some aspects of this disclosure may be combined with one or more other aspects of this disclosure to form new aspects.

Various examples are described in more detail below.

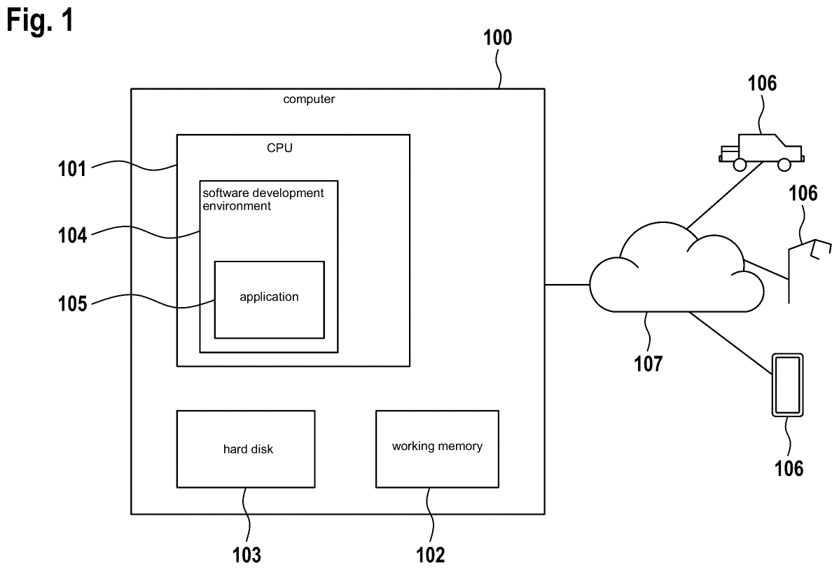

FIG. 1 shows a computer 100 for the development and/or testing of software applications.

The computer 100 comprises a CPU (central processing unit) 101 and a working memory (RAM) 102. The working memory 102 is used for loading program code, e.g., from a hard disk 103, and the CPU 101 executes the program code.

In the present example, it is assumed that a user intends to develop and/or test a software application with the computer 100.

For this purpose, the user executes a software development environment 104 on the CPU 101.

The software development environment 104 enables the user to develop and test an application (i.e., a software) 105 for different devices 106, i.e. target hardware, such as embedded systems for controlling robot devices, including robot arms and autonomous vehicles, or also for mobile (communication) devices. For this purpose, the CPU 101 can execute an emulator as part of the software development environment 104 in order to simulate the behavior of the particular device 106 for which an application is being or has been developed. If it is used only for testing software from another source, the software development environment 104 can also be regarded as or configured as a software testing environment.

The user can distribute the finished application to corresponding devices 106 via a communication network 107. Rather than via a communication network 107, this can also be done in another way, for example by means of a USB stick.

However, before this happens, the user should test the application 105 in order to prevent an improperly functioning application from being distributed to the devices 106. This may also be the case if the user has not written the application 105 on the computer 100 himself. In particular, it can occur that the user does not have the source code of the application, but only its executable code (i.e., the binary program), i.e. if the application (computer program) 105 is a black-box computer program from the tester's point of view.

One test method is so-called fuzzing. Fuzzing or fuzz-testing is an automated software test method in which invalid, unexpected or random data are supplied as inputs to a computer program to be tested. The program is then be monitored for exceptions such as crashes, missing failed built-in code assertions or potential memory leaks.

Typically, fuzzers (i.e., test programs that use fuzzing) are used to test programs that process structured inputs. This structure is for example specified in a file format or in a file format or protocol and distinguishes between valid and invalid inputs. An effective fuzzer generates semi-valid inputs that are “valid enough” not to be rejected immediately by the input parser of the program to be tested, but “invalid enough” to cover unexpected behaviors and borderline cases that are not being handled properly in the program to be tested.

The terminology used in connection with fuzzing is described below:
Fuzzing or fuzz-testing is the automated testing process of sending randomly generated inputs to a target program (program to be tested) and observing its response.
A fuzzer or a fuzzing engine is a program that automatically generates inputs. Thus, it is not linked to the software to be tested (e.g., through instrumentation). However, the fuzzer has the ability to instrument code, generate test cases, and execute programs to be tested. Conventional examples are AFL and libFuzzer.
A fuzz target is a software program or a function that is to be tested by fuzzing. A main feature of a fuzz target should be that it accepts potentially untrusted inputs that are generated by the fuzzer during the fuzzing process.
A fuzz test is the combined version of a fuzzer and a fuzz target. A fuzz target can then be instrumented code in which a fuzzer is linked to its inputs (i.e. delivers them). A fuzz test can be executed. A fuzzer can also start, observe and stop a plurality of fuzz tests, i.e. perform a plurality of test runs (normally hundreds or thousands per second), each with a slightly different input generated by the fuzzer.
A test case is a specific test input and a specific test run from a fuzz test. (Accordingly, each test input has (at least) one test case and each test case has one test input). Normally, test runs of interest with regard to reproducibility are saved (finding new code paths or crashes). In this way, a specific test case with the corresponding input can also be executed on a fuzz target which is not connected to a fuzzer, e.g. the release version of a program.
Coverage-guided fuzzing uses code coverage information as feedback during fuzzing in order to recognize whether an input has caused the execution of new code paths or blocks.
Generation-based fuzzing uses prior knowledge about the target program (fuzz target) in order to create test inputs. An example of such prior knowledge is a grammar which corresponds to the input specification of the fuzz target, i.e. the input grammar of the fuzz target (i.e. of the program to be tested).
Mutation-based fuzzing generates new test inputs by making small changes to initial test inputs that keep the test input valid but trigger new behavior.
A seed is an initial test input that is used as a starting point for mutation-based fuzzing. Seeds are generally provided by the user.
The energy of a seed is the number of test cases that are generated from a seed by mutations.
The power schedule is the importance that a mutation-based fuzzer assigns to the seeds, which directly affects the order in which the seeds for mutation are queued for test input generation.
The corpus is a collection of the test inputs that are generated during the fuzzing process. These test inputs are normally derived based on the seeds and/or other test inputs already generated (typically by mutation). The corpus grows in the course of fuzzing since more and more test inputs are generated and added.
Static instrumentation is the insertion of instructions into a program (to be tested) in order to obtain feedback about its execution. It is usually realized by the compiler and can indicate, for example, the code blocks reached during execution.
Dynamic instrumentation is the control of the execution of a program (to be tested) during runtime in order to generate feedback from the execution. It is usually realized by operating system functionalities or by the use of emulators.
A debugger is a device or a program that can control a target device or target program and can provide functions, e.g., for retrieving register or memory values and for pausing and executing the target program in single steps.

In the following, a black-box fuzzer setting is considered, specifically for testing software for an embedded system, i.e., the software development environment 104 has a set of seeds and implements a black-box fuzzer for testing a computer program 105 for a target device 106 which is an embedded system.

Black-box fuzzing is a common test method if no source code is available. However, the majority of fuzzing research focuses on improving fuzzing in the gray-box or white-box configuration, since the black-box configuration is the most difficult to improve. Coverage-driven fuzzers, such as AFL, generally use static source code instrumentation in order to obtain feedback on the coverage of the target while processing a test input. AFL enables coverage-driven fuzzing for ARM-based microcontrollers via the Embedded Trace Macrocell (ETM) hardware tracing interface. For closed-source target programs, dynamic instrumentation can be used instead, i.e. the binary file to be tested is instrumented during runtime without instrumentation being compiled into the target.

In embedded systems, static instrumentation for fuzzing is more difficult to achieve than in non-embedded systems for the following reasons:
The fuzzer normally runs on a computer other than the embedded system. Therefore, the code coverage information must be transferred.
An entire system, which normally consists of a plurality of components, is tested. The software can contain third-party libraries and software components from other providers or customers. If these components are delivered as binary files, they can be regarded as closed-source components that cannot be modified. Therefore, closed-source components may not be instrumented by the compiler.
Static instrumentation increases code size, which can be critical on embedded systems with limited resources, i.e. there is not enough memory for instrumentation or additional functionalities that support fuzzing.

Dynamic instrumentation is only possible with specific operating systems and even in this case the code coverage information must be transferred (which slows down testing considerably). In addition, the program code can also be located in a read-only memory of the executing system, so that no changes can be made to it.

An alternative approach to instrumentation is to execute the embedded system software in a system emulator such as QEMU. The transparency of the emulator is used to collect feedback for fuzzing. Unfortunately, setting up an emulator for a specific target can require a huge amount of work. This is because the software for an embedded system generally depends on the availability of external components such as sensors and actuators. If these components are missing in the emulator, the software (executed by the emulator) will most likely take different paths and therefore cannot be compared with real processes. Therefore, not only the instruction set of the particular embedded system must be emulated, but also all expected hardware peripherals.

Hardware-in-the-loop (HiL) approaches such as Avatar2 counter this difficulty by forwarding all IO requests from the emulator to the hardware and transferring the result back again (peripheral proxying). However, HiL constitutes a major bottleneck.

In view of the above difficulties with black-box fuzzing, according to various embodiments, an oracle for estimating the coverage that can be achieved by means of test inputs is trained with by machine learning and used to guide the fuzzing (specifically, the selection of test inputs that are supplied to the computer program to be tested).

Thus, according to various embodiments, the fuzzing of software for embedded devices is improved by using an oracle that is able to estimate the code coverage of a test input (and thus a test case) on the executing system, without actually measuring it. This enables the performance of gray-box fuzzing for embedded devices (i.e., black-box fuzzing but with information about the coverage), without the effort of an exact coverage measurement. For example, the software development environment 104 implements a machine learning model (which it also optionally trains itself).

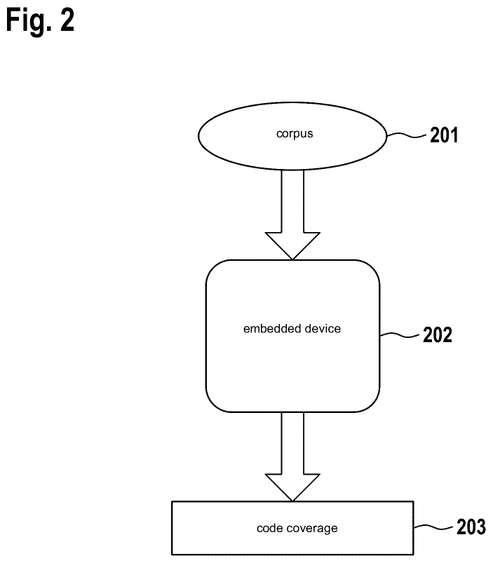

FIG. 2 illustrates the (training) data capture for training a machine learning model to predict coverage (also referred to herein as a “(coverage) oracle”).

Training data can be collected by executing test cases on the embedded device 202 and observing the code coverage 203. For this purpose, existing test inputs from the corpus 201 (in particular seeds) can be used, or a standard black or gray-box fuzzer can be used to generate new test inputs from existing test inputs. For each of the executed test cases, the coverage on the embedded system 202 is observed.

In order to retrieve coverage information from the embedded system 202 (and thus observe the coverage), the embedded system 202 can be used, for example, in the above-mentioned HiL setup (i.e., the computer 100 sends the test inputs to the particular embedded system 106 and receives coverage information from the embedded system 106).

For example, this is done by means of a debugger, i.e., the computer 100 (or “host”) sends the test inputs and debugging commands in order to control the embedded system 106 to execute the computer program to be tested with the test inputs (via a debugging interface), and receives coverage information from the embedded system 106 (e.g., via debugging responses through the debugging interface). In this case, the communication network 107 thus comprises the debugging interface and a channel for the test inputs (e.g., via Wifi, Bluetooth or a serial connection). For example, a debugger is connected to the microcontroller of the embedded system 106, from which the execution can be controlled. A simple option for ascertaining the coverage in such a setting is to run through the program code of the computer program to be tested in individual steps and simultaneously log the program addresses achieved. Alternatively, an emulator with the peripheral proxying technique can be used to collect coverage data or instrumentation can be used. It should be noted that these techniques for capturing coverage drastically increase the runtime overhead and are therefore unsuitable for coverage-driven fuzzing. However, with the method provided here, they only occur when capturing the training data (or when verifying the oracle's predictions) and not during the actual fuzzing.

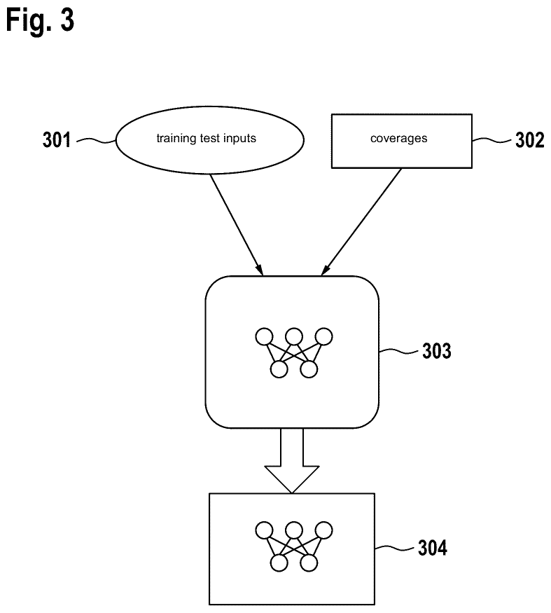

FIG. 3 illustrates the training of the oracle by means of the training data captured according to FIG. 2.

The training test inputs 301 ascertained according to FIG. 2 and the coverages 302 observed for them (as ground truth) are used as training data for training the oracle 303, so that a trained oracle 304 is generated, which can predict, based on a test case (i.e., a test input), a code coverage that will be achieved when the computer program to be tested is executed on the target embedded system.

In practice, the oracle 303, 304 can be implemented by a machine learning model (e.g., a neural network), which is trained with the test cases as input and the coverage information (per test case) as the target task (i.e., as ground truth).

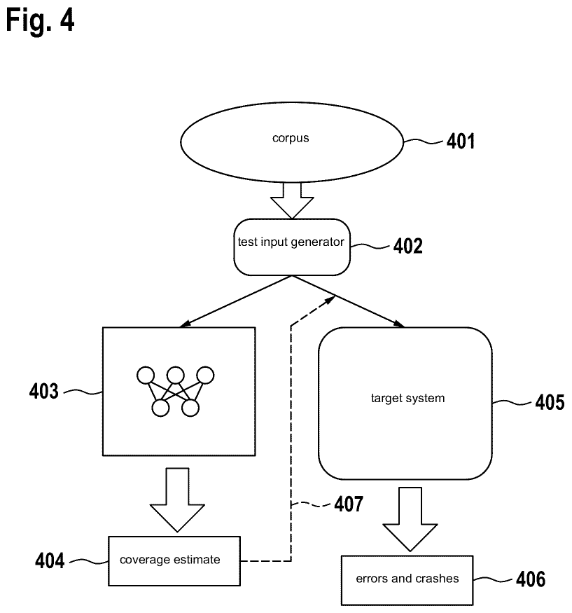

FIG. 4 illustrates an oracle-controlled fuzzing by means of the oracle trained according to FIG. 3.

With oracle-driven fuzzing, test inputs are generated by a test input generator 402 based on test inputs from the corpus 401.

Each of these test inputs is supplied to the trained oracle 403, which predicts a coverage for the test input, i.e., in order to obtain a coverage estimate 404.

Depending on the coverage estimate, the test case (corresponding to the test input) is executed on the target system 405 (i.e., the test input is used as input for the target (black-box) program and this is executed) in order to observe errors and crashes 406. This dependency is illustrated in FIG. 4 by the dashed arrow 407.

The test case is executed on the target system 405 if the coverage estimate signifies an increase in the overall coverage previously achieved in the course of fuzzing (e.g., the oracle 403 predicts that the test case will achieve functions that have not yet been previously achieved in the course of fuzzing).

If a test input increases the (overall) coverage (at least according to the oracle), it can be added to the corpus 401 (as is usual with fuzzing). For a test case for which the oracle predicts an increase in (overall) coverage, it is also possible to check whether this is actually the case when the test case is executed. This can be done in one of the ways described above (e.g., a HiL setup), which is complex, as described above, but is only performed in the case of test inputs that increase the overall test coverage according to the oracle.

A common gray-box fuzzer can be used, which uses the coverage estimates that the oracle creates per test case to select the test cases that are executed without having to access the expensive coverage capture mechanism of the embedded device. The oracle thus achieves the goal of providing a fast mechanism for ascertaining coverage and transforming fuzzing from black box to gray box.

Optionally, the procedure in FIGS. 2, 3 and 4 can also be repeated multiple times. This means that additional training data can be collected at a later point of time in order to update the oracle for more accurate coverage predictions.

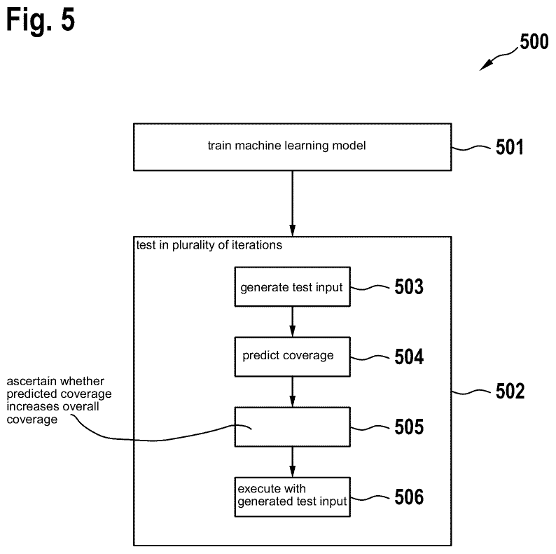

In summary, according to various embodiments, a method is provided as shown in FIG. 5.

FIG. 5 shows a flowchart 500 illustrating a method for testing a computer program according to an embodiment.

In 501, a machine learning model is trained to predict, for each test input supplied thereto, a coverage of the computer program that is achieved when the computer program is executed with the test inputs as inputs (i.e., to predict a particular coverage for a particular test input supplied thereto).

In 502, the computer program is tested in a plurality of iterations, wherein in each iteration
a test input is generated in 503 (e.g., by mutating a previous test input or a seed from a corpus);
in 504, the trained machine learning model is used to predict a coverage of the computer program that is achieved when the computer program is executed with the generated test input as input (i.e., the generated test input is supplied to the (trained) machine learning model, and the output of the machine learning model in response to this input is taken as an estimate of the coverage);
in 505, it is ascertained whether the predicted coverage increases an overall coverage previously achieved by testing the computer program (i.e., by testing with the previous test inputs); and
in 506, in response to ascertaining that the predicted coverage increases the overall coverage previously achieved by testing the computer program, the computer program is executed with the generated test input (and otherwise not, but a new test input is generated; however, further iterations can also be interspersed in the iterations, in which further iterations the machine learning model is not used, i.e. the selection of the test input is not dependent on the prediction of the machine learning model).

The method in FIG. 5 can be performed by one or more computers with one or more data processing units. The term “data processing unit” may be understood as any type of entity that enables processing of data or signals. The data or signals can be treated, for example, according to at least one (i.e. one or more than one) special function which is performed by the data processing unit. A data processing unit can comprise or be formed from an analog circuit, a digital circuit, a logic circuit, a microprocessor, a microcontroller, a central processing unit (CPU), a graphics processing unit (GPU), a digital signal processor (DSP), an integrated circuit of a programmable gate array (FPGA) or any combination thereof. Any other way of implementing the respective functions described in more detail herein may also be understood as a data processing unit or logic circuit assembly. One or more of the method steps described in detail here can be executed (e.g. implemented) by a data processing unit by one or more special functions that are performed by the data processing unit.

The approach of FIG. 5 is used for testing a program, for example control software for a robot device. The term “robot device” may be understood to refer to any technical system, such as a computer-controlled machine, a vehicle, a household appliance, a power tool, a production machine, a personal assistant or an access control system. The control software can also be used for data-processing systems, such as a navigation device.

The method of FIG. 5 is performed, for example, by a test arrangement (e.g., the computer 100 and target device 106 in FIG. 1).

Although specific embodiments have been depicted and described herein, a person skilled in the art will recognize that the specific embodiments shown and described may be replaced with a variety of alternative and/or equivalent implementations without departing from the scope of protection of the present invention. This application is intended to cover any adaptations or variations of the specific embodiments discussed herein.

What is claimed is:

1. A method for testing a computer program, the method comprising the following steps:
training a machine learning model to predict, for each test input supplied to the machine learning model, a coverage of the computer program that is achieved when the computer program is executed with the test input as inputs;
testing the computer program in a plurality of iterations, wherein in each iteration a test input is generated;
using the trained machine learning model to predict a coverage of the computer program that is achieved when the computer program is executed with the generated test input as input;
ascertaining whether the predicted coverage increases an overall coverage previously achieved by testing the computer program; and
in response to ascertaining that the predicted coverage increases the overall coverage previously achieved by testing the computer program, executing the computer program with the generated test input.

2. The method according to claim 1, wherein, in each iteration, the test input is generated from a different test input depending on whether the coverage predicted by the trained machine learning model for the different test input increases the overall coverage achieved by the testing prior to executing the computer program with the different test input as input.

3. The method according to claim 1, further comprising:
checking whether executing the computer program with the generated test input has increased the overall coverage achieved during testing of the computer program; and
in response to the execution of the computer program with the generated test input having increased the overall coverage achieved during testing of the computer program, adding the generated test input to a set of test inputs from which test inputs for further iterations are generated.

4. The method according to claim 1, further comprising:
generating the test input on a test system;
ascertaining the coverage of the computer program on the test system; and
in response to the test system ascertaining that the predicted coverage increases the overall coverage previously achieved by testing the computer program, executing the computer program with the generated test input on a system embedded with the test system.

5. A software test system configured to test a computer program, the test system configured to:
train a machine learning model to predict, for each test input supplied to the machine learning model, a coverage of the computer program that is achieved when the computer program is executed with the test input as inputs;
test the computer program in a plurality of iterations, wherein in each iteration a test input is generated;
use the trained machine learning model to predict a coverage of the computer program that is achieved when the computer program is executed with the generated test input as input;
ascertain whether the predicted coverage increases an overall coverage previously achieved by testing the computer program; and
in response to ascertaining that the predicted coverage increases the overall coverage previously achieved by testing the computer program, execute the computer program with the generated test input.

6. A non-transitory computer-readable medium on which are stored instructions for testing a computer program, the instructions, when executed by a processor, causing the processor to perform the following steps:
training a machine learning model to predict, for each test input supplied to the machine learning model, a coverage of the computer program that is achieved when the computer program is executed with the test input as inputs;
testing the computer program in a plurality of iterations, wherein in each iteration a test input is generated;
using the trained machine learning model to predict a coverage of the computer program that is achieved when the computer program is executed with the generated test input as input;
ascertaining whether the predicted coverage increases an overall coverage previously achieved by testing the computer program; and
in response to ascertaining that the predicted coverage increases the overall coverage previously achieved by testing the computer program, executing the computer program with the generated test input.
